(19) United States
(12) Patent Application Publication
(10) Pub. No.: US 2001/0032188 A1
(43) Pub. Date: Oct. 18, 2001

(54) Information distribution system

(76) Inventors: Yoshiyuki Miyabe, Osaka (JP); Shigeshi Arai, Osaka (JP)

Correspondence Address: NIXON PEABODY, LLP, 8180 GREENSBORO DRIVE, SUITE 800, MCLEAN, VA, 22102, US

(21) Appl. No.: 09/792,062

(22) Filed: Feb. 26, 2001

(30) Foreign Application Priority Data
Feb. 25, 2000 (JP) 2000-048826

(51) Int. Cl. G06F 17/60; H04K 1/00; H04L 9/00

(52) U.S. Cl. 705/57; 705/59; 705/51

(57) ABSTRACT

A program distribution system, capable of decreasing the load of distributing programs and capable of managing transfer and installation of programs at distribution destinations by the distribution source, is disclosed. Computer software distributed to a PC 116 includes a program for transfer, historical information of program transfer, a program for installation and an application program(s). The transfer program adds both information on a terminal to be a destination of transfer and information on a media used for the transfer to the historical information, and it transfers to a PC 172 the whole software including itself. The installation program transmits the historical information to a distribution management device 103 via a network 151 and an external connection device 104. The distribution management device 103 receives the historical information and makes a response to the PC 172 whether or not installation of the software therein is permitted. The installation program performs processing for installation upon receipt of a response of permission.

### CROSS-REFERENCE TO RELATED APPLICATIONS

The disclosure of Japanese Patent Application No. 2000-048826 filed on Feb. 25, 2000 including specification, claims, drawings and summary is herein incorporated by reference in its entirety.

### FIELD OF THE INVENTION

The present invention relates to a program distribution system, distributing application programs and/or application data to multiple terminal devices, and a distribution program recording medium, data distribution system and data recording medium, and a distribution control device for these.

### BACKGROUND OF THE INVENTION

Conventionally, application programs such as for word-processing and spreadsheet software have been distributed to users mainly in the form of recording mediums such as optical discs so on. Application data recording information such as music and/or movies have been distributed in similar way. In the distribution method of application programs and application data (hereinafter both referred to as “application” for short), generally, the distributor produces recording mediums in the number more than that the applications to be distributed and deliver them to each of the users. The user who received the medium sets it to their terminal device and enjoys the application.

### SUMMARY AND OBJECT OF THE INVENTION

As discussed above, according to the invention the load on the distribution side can be reduced and efficient distribution via a variety of paths becomes possible, while the distributed program can be controlled by the distribution side, thereby to achieve high practical effect.

(1) An information distribution system in accordance with the present invention: comprising

an information distribution management device managing distribution of information and a terminal connected to the management device so as to communicate with each other,

wherein the information to be distributed is distributed to the terminal with a utilization program for performing processing required to use the information,

wherein the terminal device performs processing for utilization of the information in accordance with processing of the utilization program,

and wherein at beginning of the utilization processing, the utilization program asks the device for permission of the utilization processing as a result of communication therewith and performs the utilization processing on receipt of the permission from the device.

(2) An information distribution management device in an information distribution system, managing distribution of information, in accordance with the present invention:

wherein the device is connected to a terminal device so as to communicate with each other,

and wherein the device returns permission of processing for utilization of the distributed information in response to a demand for the permission which is transmitted by the terminal device at beginning of use of the distributed information in accordance with a utilization program distributed with the information.

(3). A data storage medium, storing a program for managing distribution of information by which a computer functions as an information distribution management device, in accordance with the present invention:

wherein the program controls the computer to return permission of processing for utilization of the distributed information in response to a demand for permission which is transmitted by a terminal device at beginning of use of the distributed information in accordance with a utilization program distributed with the information.

(4) A program for managing distribution of information by which a computer functions as an information distribution management device, in accordance with the present invention:

wherein the program performs processing in which permission of processing for utilization is returned in response to a demand for permission which is transmitted by the terminal device at beginning of use of the distributed information in accordance with a utilization program distributed with the information.

(5) A terminal device, in an information distribution system, connected to an information distribution management device so as to communicate with each other, in accordance with the present invention:

wherein the terminal device performs processing for utilization of information in accordance with processing of a utilization program distributed with the information,

and wherein at beginning of the utilization processing, the utilization program asks the device for permission of processing of the utilization processing as a result of communication therewith and performs the utilization processing on receipt of the permission of the processing from the device.

(6) A data storage medium, storing a utilization program for performing processing required to use distributed information with a computer, in accordance with the present invention:

wherein the program asks for permission of processing for utilization of the information as a result of communication with an information distribution management device

and wherein the program makes the computer to perform the utilization processing on receipt of the permission from the device.

(8) A utilization program for performing processing required to use distributed information with a computer, in accordance with the present invention:

wherein the program asks for permission of processing for utilization of the information as a result of communication with an information distribution management device

and wherein the program makes the computer to perform the utilization processing on receipt of the permission from the device.

(29) A data storage medium, in accordance with the present invention: storing information to be distributed, historical information of its transfer and a utility application, wherein the historical information is stored at a region for storing history of transfer in a past and at another region for storing a new history of transfer,

and wherein the new history is additionally written therein with the utility application executed by the terminal device at which the information is distributed.

(30) A historical information storage medium, in accordance with the present invention: storing historical information of information to be transferred associated with each other, wherein the historical information of the transferred information is recorded for every transfer of the information at separate regions,

and wherein storage medium has a structure in which historical information is additionally recorded therein for every transfer of information with a terminal device, which performs the transfer of the information.

(31) A tracking method for recording a distribution path of information distributed to a terminal device connected one of directly and indirectly with an information distribution management device, in accordance with the present invention: the method being used at the management device, wherein the information to be distributed is transmitted together with a program for transferring the information,

wherein the transfer program updates the information on distribution path and transmits to the management device the updated information on distribution path when information is transferred to another device with the terminal device,

and wherein the distribution path for the information is recorded in the management device thereby the distribution path for the information is tracked.

(32) A method of distributing information through one of a network and a media, wherein a distribution source adds to information to be distributed a utilization program, which makes the information usable and distributes the resultant information, in accordance with the present invention:

and wherein at an information user receiving the information, the information is not able to use on receipt of permission of use thereof which is obtained by utilizing the program.

(33) A system comprising a program distribution management device for managing information on program distribution and terminal devices connected to the management device via a communication line, in accordance with the present invention: wherein on a program storage medium inserted in a terminal device, an application program and an installation program for installing the application program into the terminal device is recorded,

wherein the installation program transmits to the management device a request for permission as to the installation via the communication line,

and wherein installation processing of the application program is performed only when permission for the request is received from the management device.

(34) A system comprising a data distribution management device for managing information on data distribution and terminal devices connected to the management device via a communication line, in accordance with the present invention: wherein on a program storage medium inserted in a terminal device, specific application data and an installation program for installing the application data into the terminal device is recorded,

wherein the installation program transmits to the management device a request for permission as to the installation of the application data via the communication line,

and wherein installation processing of the application data is performed only when permission for the request is received from the management device.

(35) A program distribution management device in accordance with the present invention comprising:

receiving means, receiving a request for permission of distribution including information for identifying programs from a terminal device connected to the device;

recording means, recording a possibility of distribution whether or not distribution of the programs being permitted per every information for identifying the programs;

judging means, obtaining information on a possibility of distribution according to the information for identifying the programs as a result of conducting a search in the recording means when the receiving means receives a request for permission of distribution; and

transmission means, transmitting to the terminal device information on permission of the distribution when a judgement of the judging means permits the distribution.

(36) A data distribution management device in accordance with the present invention comprising:

receiving means, receiving a request for permission of distribution including information for identifying data from a terminal device connected to the device;

recording means, recording a possibility of distribution whether or not distribution of the data being permitted per every data for identifying the data;

judging means, obtaining information on a possibility of distribution according to the information for identifying the data as a result of conducting a search in the recording means when the receiving means receives a request for permission of distribution; and

transmission means, transmitting to the terminal device information on permission of the distribution when a judgement of the judging means permits the distribution.

(37) A program storage medium in accordance with the present invention storing an application program and an installation program for installing the application program into a terminal device, wherein the installation program transmits to a program distribution management device connected to the terminal device a request for permission as to installation of a program prior to install the application program into the terminal device,

and wherein installation processing of the application program is performed only when permission for the request is received from the management device.

(38) A program storage medium in accordance with the present invention storing an application data and an installation program for installing the application data into a terminal device, wherein the installation program transmits to a data distribution management device connected to the terminal device a request for permission as to installation of a program prior to install the application data into the terminal device,

and wherein installation processing of the application data is performed only when permission for the request is received from the management device.

(39) A terminal device capable of executing an application program in accordance with the present invention: wherein a program storage medium inserted therein stores an application program,

historical information of its transfer, and

a program for transferring the application program, the historical information and the transfer program itself to another terminal device,

and wherein the transfer program executes transfer processing with addition of information on a transmission media used for the transfer.

(40) A terminal device capable of processing application data, in accordance with the present invention wherein a program storage medium inserted therein stores application data,

historical information of its transfer, and

a program for transferring the application data, the historical information and the transfer program itself to another terminal device,

and wherein the transfer program performs transfer processing with addition of information on a transmission media used for the transfer.

(41) A program storage medium storing an application program in accordance with the present invention: historical information of its transfer, a program for transferring data including the application program to another terminal device, wherein the transfer program performs transfer processing with addition of information on a transmission media used for the transfer.

(42) A program storage medium in accordance with the present invention: storing an application data, historical information of transfer, a program for transferring data including the application data to another terminal device, wherein the transfer program performs transfer processing with addition of information on a transmission media used for the transfer.

(43) A system comprising a program distribution management device for managing information on program distribution and terminal devices connected to the management device via a communication line in accordance with the present invention: wherein on a program storage medium inserted in a terminal device, an application program and a program for transferring data including the application program to another terminal device is recorded,

wherein the transfer program transmits to the management device a request for permission as to the transfer via the communication line,

and wherein transfer processing is performed only when permission for the request is received from the management device.

(44) A system comprising a data distribution management device for managing information on data distribution and terminal devices connected to the management device via a communication line in accordance with the present invention: wherein on a program storage medium inserted in a terminal device, an application data and a program for transferring data including the application data to another terminal device is recorded,

wherein the transfer program transmits to the management device a request for permission as to the transfer via the communication line,

and wherein transfer processing is performed only when permission for the request is received from the management device.

(45) A storage medium storing an application program and a program for transferring data including the application program to another terminal device in accordance with the present invention: wherein the transfer program transmits to a program distribution management device connected to the terminal device a request for permission as to transfer of the program to another terminal device prior to perform transfer processing,

and wherein the transfer processing is performed only when permission for the request is received from the management device.

(46) A storage medium storing application data and a program for transferring data including the application data to another terminal device in accordance with the present invention: wherein the transfer program transmits to a data distribution management device connected to the terminal device a request for permission as to transfer of the data to another terminal device prior to perform transfer processing,

and wherein the transfer processing is performed only when permission for the request is received from the management device.

(47) A program distribution management device in accordance with the present invention comprising:

receiving means, receiving historical information on distribution of a program from a terminal device connected to the management device; and

transmission means, transmitting a message for confirming receipt of the historical information to the terminal device when the receiving means receives the historical information.

(48) A program distribution management device in accordance with the present invention comprising:

receiving means, receiving a request for permission of distribution including information for identifying programs and historical information on distribution of the program from a terminal device connected to the device;

recording means, recording a possibility of distribution whether or not distribution of the programs being permitted per every information for identifying the programs;

judging means, obtaining information on the possibility of distribution according to the information for identifying the data as a result of conducting a search in the recording means when the receiving means receives the request for permission of distribution and the historical information; and

transmission means, transmitting to the terminal device information on permission of the distribution when a judgement of the judging means permits the distribution.

(49) A data distribution management device in accordance with the present invention comprising:

receiving means, receiving historical information on distribution of application data from a terminal device connected to the management device; and

transmission means, transmitting a message for confirming receipt of the historical information to the terminal device when the receiving means receives the historical information.

(50) A data distribution management device in accordance with the present invention comprising:

receiving means, receiving a request for permission of distribution including information for identifying application data and historical information on distribution of the application data from a terminal device connected to the device;

recording means, recording a possibility of distribution whether or not distribution of the application data being permitted per every information for identifying the application data;

judging means, obtaining information on the possibility of distribution according to the information for identifying the data as a result of conducting a search in the recording means when the receiving means receives the request for permission of distribution and the historical information; and

transmission means, transmitting to the terminal device information on permission of the distribution when a judgement of the judging means permits the distribution.

The “distributed information” in the present invention includes not only computer a program(s) but also character data, image data and animation data and so on.

The term “the application of information” refers to the application of the information in some forms at the terminal device. For example, the term also means transferring the information, installation thereof into the device and so on.

The term “distribution” in this invention forms a concept in which information is not only transmitted through a network(s) and so on under an on-line basis but also information is transmitted in a form of a portable recording medium such as a flexible disk(s) and so on.

The term “install/installation” in this invention refers to a process capable of running/operating a program(s)/data and the like on a computer device and/or capable of viewing these.

The term “application program” in this invention refers to a program(s), which is a subject of the distribution that not only represents the literature in the narrow sense of the word but also forms a concept including operating system and relevant ones.

The term “application data” in this invention refers to data, which is subject of the distribution.

The term “transfer/transferred” in this invention refers to a process in which at least information, which is subject of the distribution, is transmitted to other device, passing that information to other device through portable recording medium, recording the information into the recording medium in order to pass the information to other device and recording the information into the device from the medium in order to pass the information thereto.

The term “recording medium recording a program(s)” in this invention refers to a recording medium recording a program(s) therein such as a ROM(s), a RAM(s), a flexible disk(s), a CD-ROM(s), a memory card(s), a hard disk(s) and the like. The recording medium also forms a concept in which a phone line(s), a data carrying path(es) and so on are included therein. Also, the recording medium forms another concept in which a recording medium such as a hard disk(s) which is connected to the CPU and information stored therein is executed directly the CPU. The recording medium further forms a concept in which a recording medium such as a CD-ROM(s) recording a program(s) which is executed after installation therein.

The term “program(s)” in this invention refers to not only a program(s) which is directly executed by the CPU but also a program(s) being compressed, a program(s) being encrypted and so on.

### BRIEF DESCRIPTION OF THE DRAWINGS

FIG. 1a shows a system configuration of the program distribution system in one embodiment of the present invention.

FIG. 1b is a diagram showing a format of data transfer in an embodiment of the present invention.

FIG. 2 shows a configuration of the software 200 to be delivered in the same embodiment.

FIG. 3(a) is a flowchart, showing the process operation of the control program 201 stored in the software 200.

FIG. 3(b) shows an example of a display screen which is presented on the terminal screen by the control program 201.

FIG. 4 is a flowchart, showing the process operation of the transfer program 203 stored in the software 200.

FIG. 5 shows an example of a display screen which is presented on the terminal screen by the transfer program 203.

FIG. 6 is a flowchart, showing the process operation of the distribution control device 103 and the installation program 205 stored in the software 200 in the same embodiment.

FIG. 7 shows an example of data of the history information 204 stored in the software 200.

FIG. 8 shows a data structure of the data to be transmitted to a distribution control device by the installation program 205 in the same embodiment.

FIG. 9 shows a configuration of the distribution control device 103 in the same embodiment.

FIG. 10 shows an example of the database retained by the distribution information storage means 903 in the distribution control device 103.

FIG. 11 shows an example of the data of the history information 204 processed in another embodiment.

FIG. 12 shows an example of the data stored in the history information 204 of the software 200 in the another embodiment.

FIG. 13 shows a configuration of the distribution control device 103 in the another embodiment.

FIG. 14 shows an example of the database retained by the distribution information storage means 906 of the distribution control device 103 in the same embodiment.

FIG. 15 shows the contents of the database of the updated distribution information storage means 906 in the same embodiment.

FIG. 16 shows the contents of the database of the further updated distribution information storage means 906 in the same embodiment.

### DETAILED DESCRIPTION OF PREFERRED EMBODIMENTS

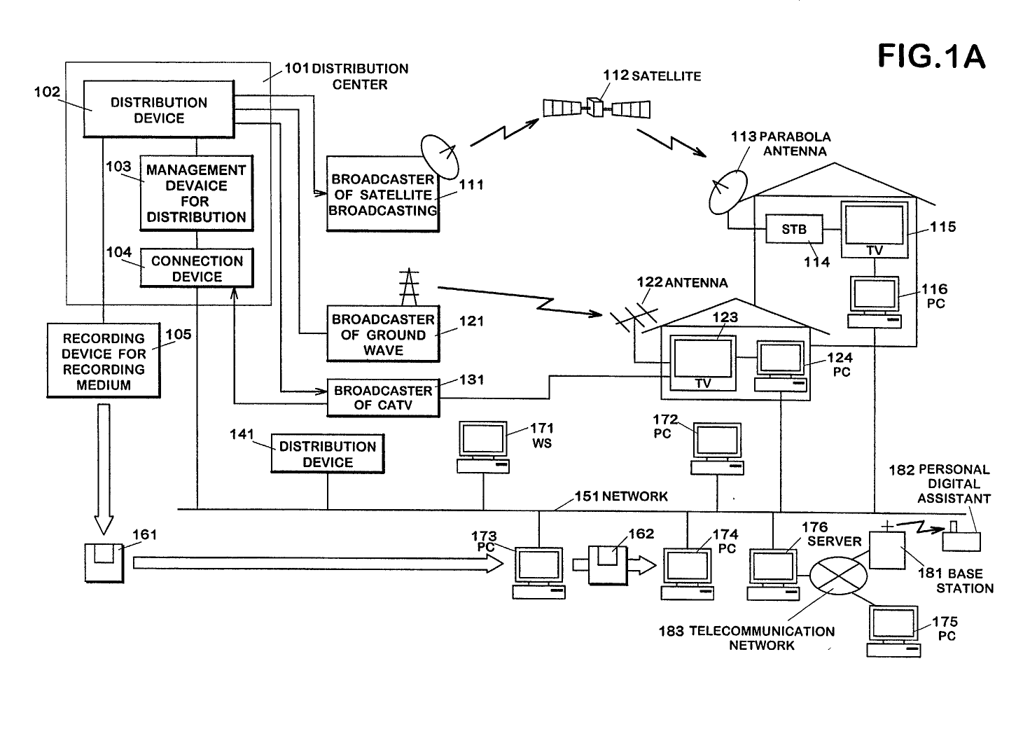

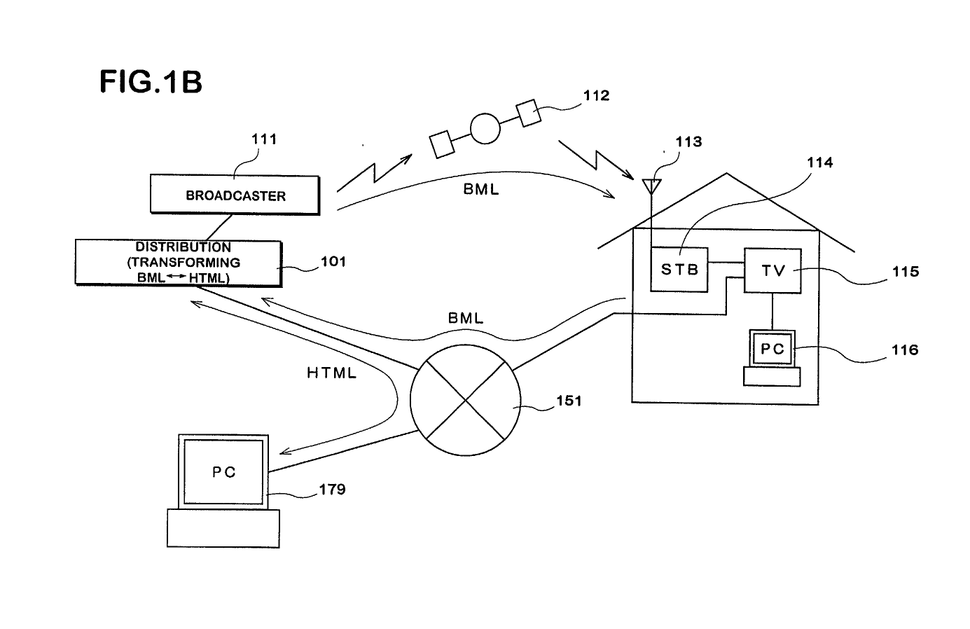

FIG. 1a shows a system configuration in one embodiment of the present invention.

A distribution center 101 is a center system to control a program to be distributed and comprises a distribution device 102, a distribution control device 103 connected to the distribution device 102, and an outside connection device 104 connected to the distribution control device 103.

The distribution device 102 is a device controlling a software to be distributed, directly connected to a satellite broadcasting station 111, a ground wave broadcasting station 121, a CATV broadcasting station 131, and a recording medium device 105, and can transfer the specific software to these connections. In addition, the distribution device 102 is also connected to a external distribution device 141 connected to a external network 151, through the distribution control device 103 and the outside connection device 104, and thus the same software can be transferred to this external distribution device 141.

This satellite broadcasting station 111 is comprising a data broadcasting function transmitting data, in addition to a normal TV broadcasting and a radio broadcasting through the satellite broadcast line, and the above software can be transmitted to each of receiving terminals of the satellite broadcasting by this data broadcast. In FIG. 1, the data including the software to be distributed is multiplexed to a broadcast wave, and in which this broadcast wave is configured to be sent to a satellite broadcast receiving antenna 113 through a relay satellite 112. The broadcast wave received by the satellite broadcast receiving antenna 113 is sent through a set-top box (hereinafter referred to as STB) 114 to an image receiving terminal 115. A user operates a STB 114 or television image receiving unit 115 controlling the STB 114, separates the desired software from the received broadcast wave and downloads it in a personal computer 116 (hereinafter referred to as PC).

Similarly, the ground wave broadcasting station 121 also multiplexes the said software to the broadcast wave and transmits to each image receiving terminal 123 through a broadcast line of the ground wave. More specifically, the broadcast wave is received by the antenna 122 and sent to an image receiving terminal 123 connected to the antenna. By operating this image receiving terminal 123, the software is separated from the received broadcast wave, and then this software is downloaded in a PC 124 connected to the image receiving terminal 123.

The CATV broadcasting station 131 is connected to the image receiving terminal 123 through a cable line and similarly multiplexes the software to the broadcast wave to transmit it to the image receiving terminal 123. The image receiving terminal 123 is configured to separate the software from the broadcast wave and download it to the PC 124.

These data broadcasting are accomplished by frequency multiplexing of the date in a retrace line section of an image signal in the case of an analog broadcast line or time-division multiplexing of the data to a transport stream in the case of a digital line.

Numeral 151 is a network such as Internet, and connected to the PC 116 and the PC 124, as well as other PCs 172-174, and workstation 171 (hereinafter referred to as WS). In addition, a PC 175 is connected to a network server 176 through a telephone line 183, and this network server 176 is connected to the network 151. A hand-held terminal 182 can be connected to the network server 176 by communicating with a base station 181 connected to a telephone line 183 by radio.

Numeral 161 is a transportable data recording medium such as CD, MO, and DVD, in which a software received from the distribution device 102 is recorded by the recording device 105 for the recording medium. Numeral 162 is a writable data recording medium, in which for example, the software that the PC 173 received is recorded, and this software is transferred by mounting and processing in the PC 174.

FIG. 1b is a conceptual diagram showing data communications between the distribution center 101 and the television image receiving unit 115 that between an ordinary PC 179 and the distribution center 101. Programs and/or data are sent from the distribution center 101 to the television image receiving unit 115 in Broadcasting Markup Language (hereinafter referred to as BML). Similarly, programs and/or data from the television image receiving unit 115 to the distribution center 101 are sent in BML.

Hypertext Markup Language (hereinafter referred to as HTML) is used between the PC 179 and the distribution center 101. Consequently, contents stored in the distribution center 101 can be viewed at the PC 179. In addition, the PC 179 is able to transmit content written in HTML to the distribution center 101.

The distribution center 101 has ability to convert languages between BML and HTML. Consequently, content written in BML used for broadcasting and content written in HTML that is popular in the Internet is able to communicate therebetween in a seamless manner.

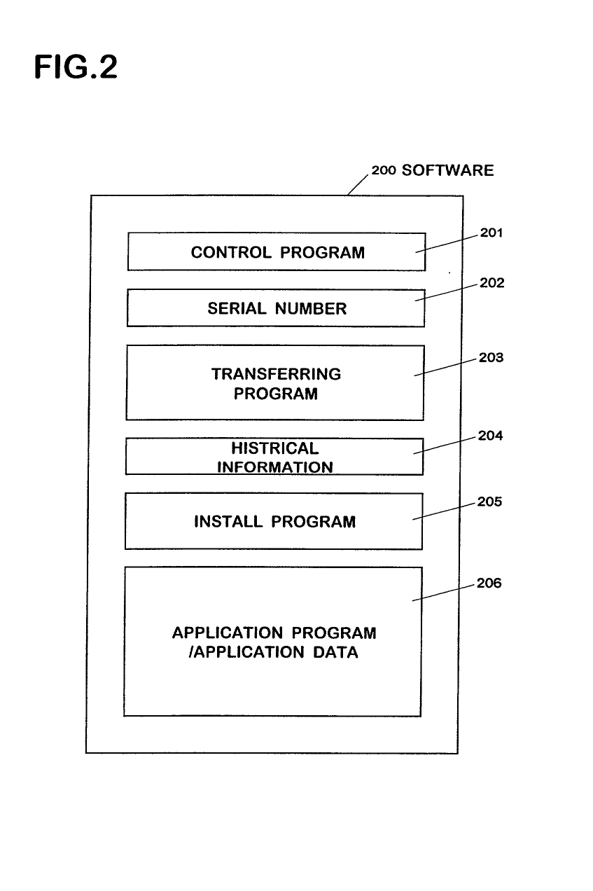

FIG. 2 is a diagram showing a data structure of software 200 distributed in this embodiment, comprising a control program 201, a serial number 202, a transfer program 203, a history information 204, an installation program 205, and application program data 206. At least one part of the application program data among these data is encrypted and recorded to prevent easy renewal of data. In addition, FIG. 2 is a diagram showing a logical memory map of these data, in which data area of these data itself are physically scrambled and recorded to be difficult for the renewal of specific area only. Serial number 202 is serial number of this software 200 and used for distribution control of the distribution center 101 described below. Application program data 206 is a data relevant to the application to be delivered and is installed in a terminal such as PC by installation program 205 described below to be executed.

For example in FIG. 1, this software is transmitted as a data of the data broadcast on the satellite communication channel comprising of the satellite broadcasting station 111, the relay satellite 112, and satellite broadcast antenna 113, and is recorded to a hard disk of the PC 116 through the STB 114 and the image receiving terminal 115. When this software 200 is started in the PC 116, the control program 201 starts at first.

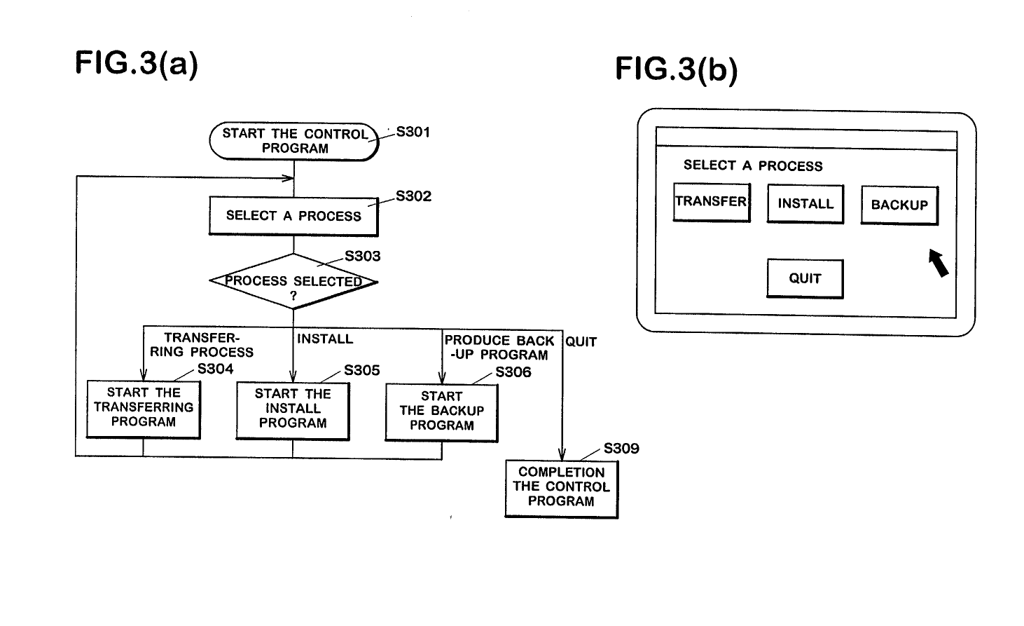

Referring now to FIG. 3, the operation of the control program 201 is described. FIG. 3(a) is a diagram showing the overall process of the control program 201. When software 200 is intended to be executed, this control program 201 is started at first and then the process is started (S301). The control program 201 displays the menu selection screen such as illustrated in FIG. 3(b) and prompts the terminal user to input the process contents (S302). A user specifies one of the three operations, such as “transfer”, “installation”, and “backup” by a pointing device such as a mouse to input the process contents. When process contents is input, its contents is determined to proceed the next process. More specifically, the transfer program (S304) when “transfer” is specified, starting the installation program (S305) when “installation” is selected, starting the backup preparation program is started (S306) when “Backup” is input, and the end process (S309) when “end” is specified.

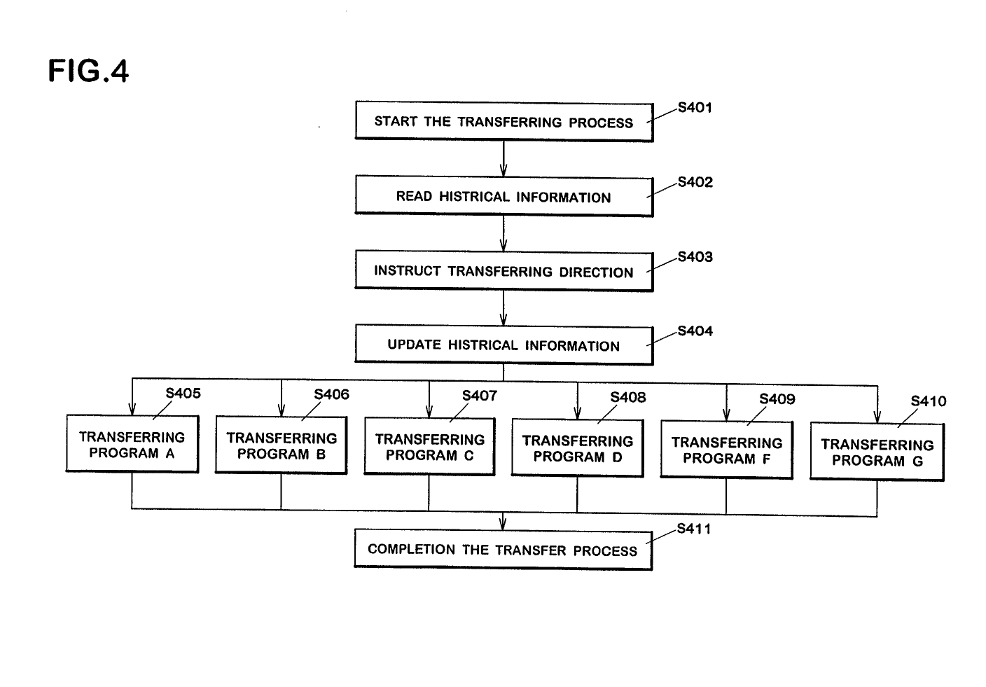

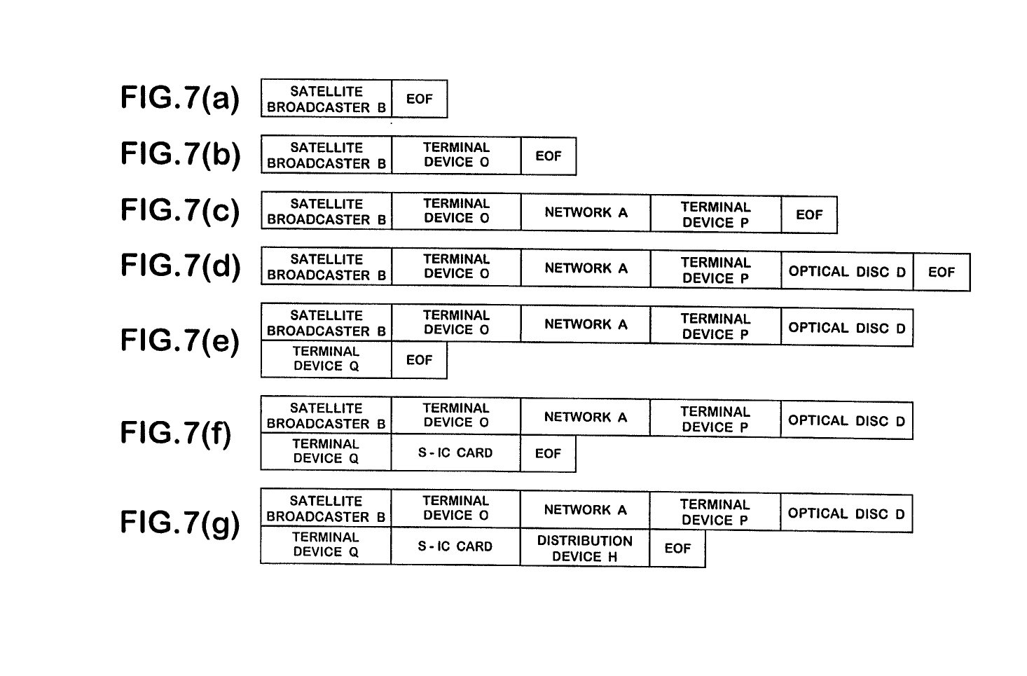

The operation performed when “transfer” being specified, will be described hereunder. The transfer program 203 is started by this process. The process contents of this program are as shown in FIG. 4. More specifically, the transfer program is started (S401) at first, and the history information 204 is read. When the software 200 is transmitted through the data broadcast of the satellite broadcast as this example is showing, the data shown in FIG. 7(a) is recorded as this history information.

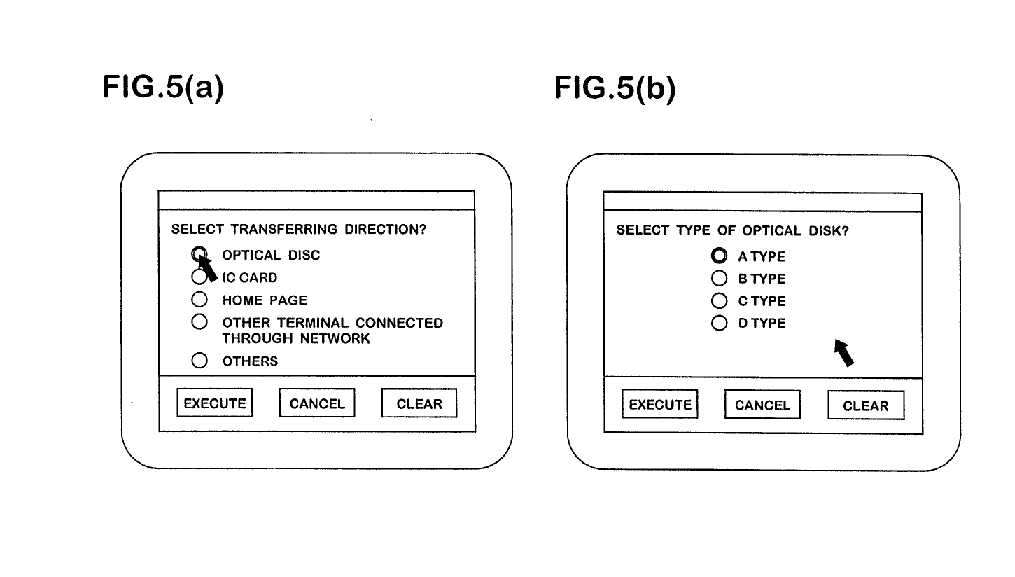

That is, the information relevant to the station which carried out the satellite broadcasting (at the case of this example, the name of the broadcasting station, “B satellite broadcast station”) and the information specifying the end of the file (illustrated as “EOF”) are recorded. In downloading to PC 116, the information relevant to this PC (at the case of this example, the identification name of terminal, “terminal O”) is added and updated as shown in FIG. 7(b). At this point, the transfer program 203 displays a window as the showed in FIG. 5(a) on to the screen of PC 116, and waits for the designation of the forwarding address by the user. When the user wants to designate the PC 172 of FIG. 1 as the forwarding address, the user may click the “Other terminals connected to the network” with the pointing device. Subsequently, information designated the PC 172 (at the case of this example, “terminal P”) is input (S403).

When a selection “optical disk” is made on the screen shown in FIG. 5(a), another screen to facilitate an input of a more detailed type of the disk (such as CD-R, MD so on) is displayed as shown in FIG. 5(b). As a consequence, the type of the optical disk can be known.

In this way, if the forwarding address of the software 200 is designated, the history information 204 read by using this information is updated. At the case of this example, the network name “A-network” of information showing the kind of a transmission medium and the terminal title “terminal P” of information showing the terminal of the forwarding address are added, to be as shown in FIG. 7(c). Subsequently, depending on this designated transmission medium and forwarding address, the transfer program corresponding to this transfer process is executed. one transfer program that can transmit the software 200 through “A-network” to “terminal P” is executed. In FIG. 4 Among the transfer programs A-G, and then the main body of the software 200 is transferred (S405 or S410). In addition, in this transferred software 200, the history information 204 is substituted by the updated information (at the case of this example, is the contents of FIG. 7(c)).

The network (for example the Internet, local area network within the office and so on) used for performing transfer is known by detecting the choice of the user. The type of the network can also be determined with the terminal by detecting the type of a network connected to a destination terminal of the transfer.

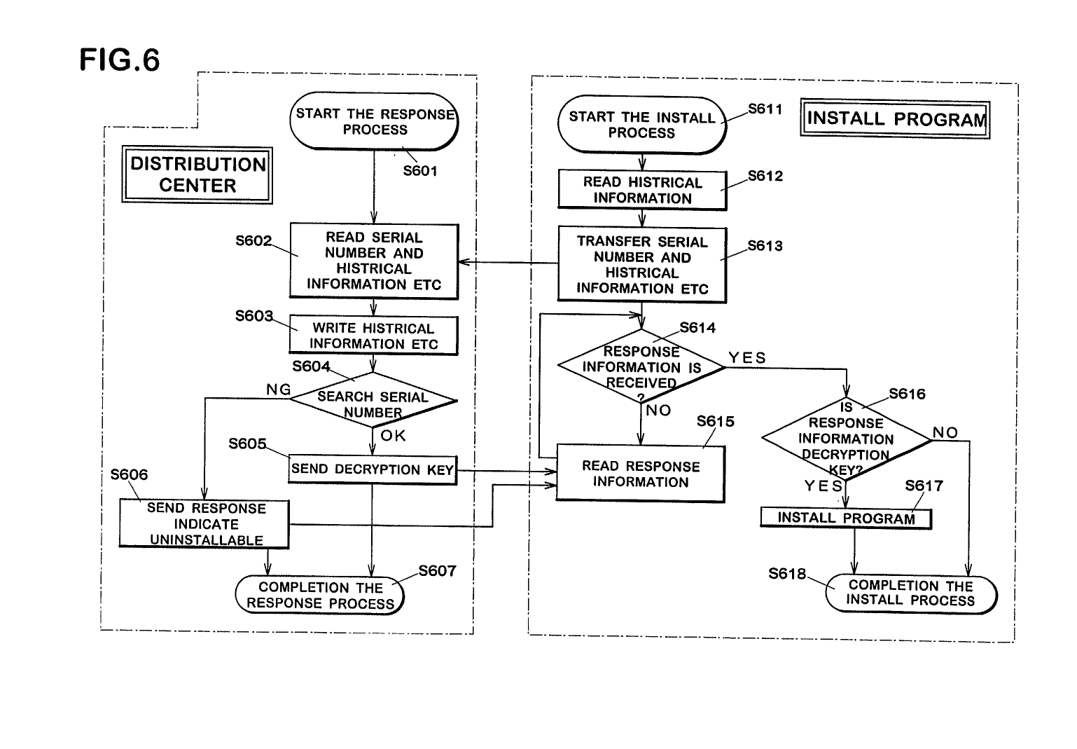

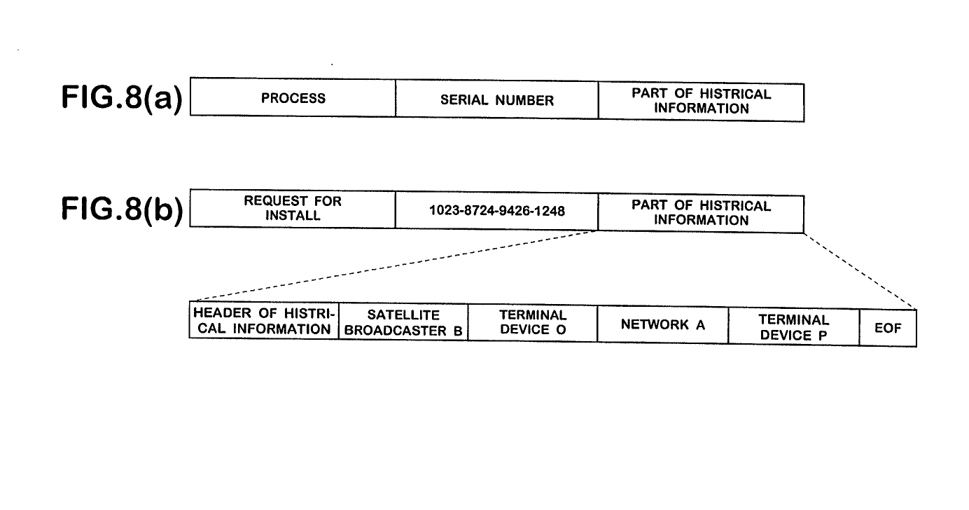

In PC 172, the process operation when the control program 201 starts the installation program 205 (S305 in FIG. 3) is described on the basis of FIG. 6. The reception process program is previously started in the distribution control device 103 of the distribution center 101 (S601). When the installation program is initially started in the control program 201 (S611) process, reading of the history information 204 recorded in this same software is carried (S612). The contents of the history information 204 at this point are the state tried of FIG. 7(c) which the process described above. Accessing through network 151 to the network 151 is set out. When the logical connection through the outside connection device 104 of the distribution center 101 to the distribution control device 103 is processed, its serial number 202 and the history information 204 are packaged, and, according to the configuration illustrated in FIG. 8(a), the data such as shown in FIG. 8(b) is transmitted. More specifically, that is packeted information of the installation permission request for requesting for the permission, the serial number of the software (in this example, [1023-8724-9426-1248]), and the history information portions added the header to the contents of the history information of FIG. 7(c).

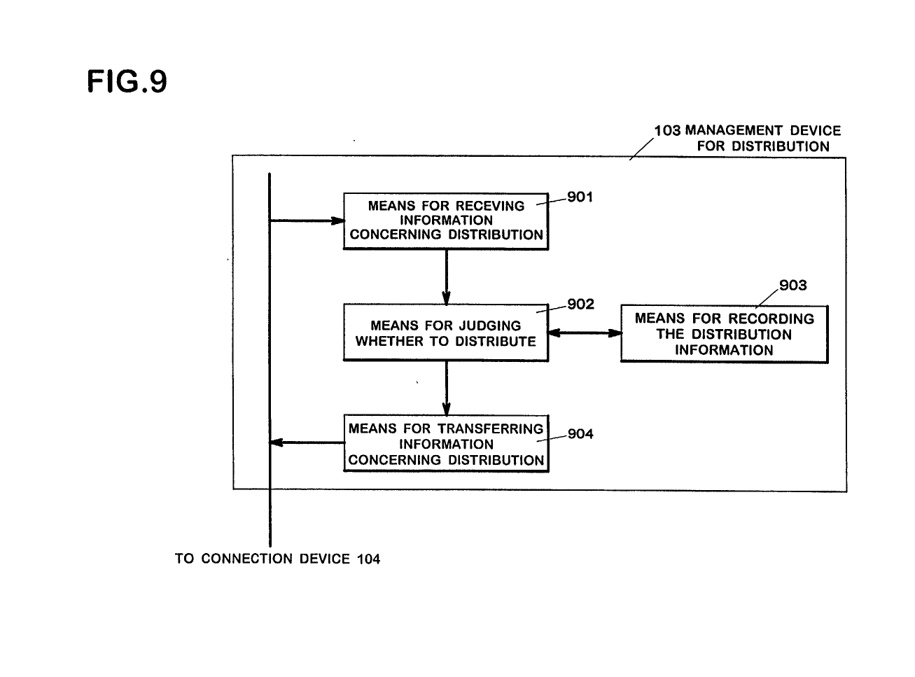

The distribution control device 103 receives this information (S602). FIG. 9 is a diagram showing the configuration example of the distribution control device 103. This distribution control device comprises of distribution related information receiving means 901 for connecting to the bus from the outside connection device 104 to receive information related to the distribution, distribution information storage means 903 for holding information related to the distribution described below, distribution propriety determination means 902 for inquiring as it refers to information holding by this distribution information storage means 903 to determine the propriety of the distribution on the basis of the information in the distribution information receiving means 901 and updating of the necessary data, and distribution related information transmission means 904 for outputting the key information described below on the basis of the determination result of this distribution propriety determination means 902 through the bus to the outside connection device 104. This distribution control device 103 can be built on the general-purpose computer system. In that case, the system is implemented the distribution information storage means 903 as a database and the 3 other means by programming this function.

The distribution related information reception means 901 transfers the received history information to the distribution propriety determination means 902. This distribution propriety determination means 902 accesses to the distribution information storage means 903 to process, for example, recording of the history information and inquiry of to the serial number.

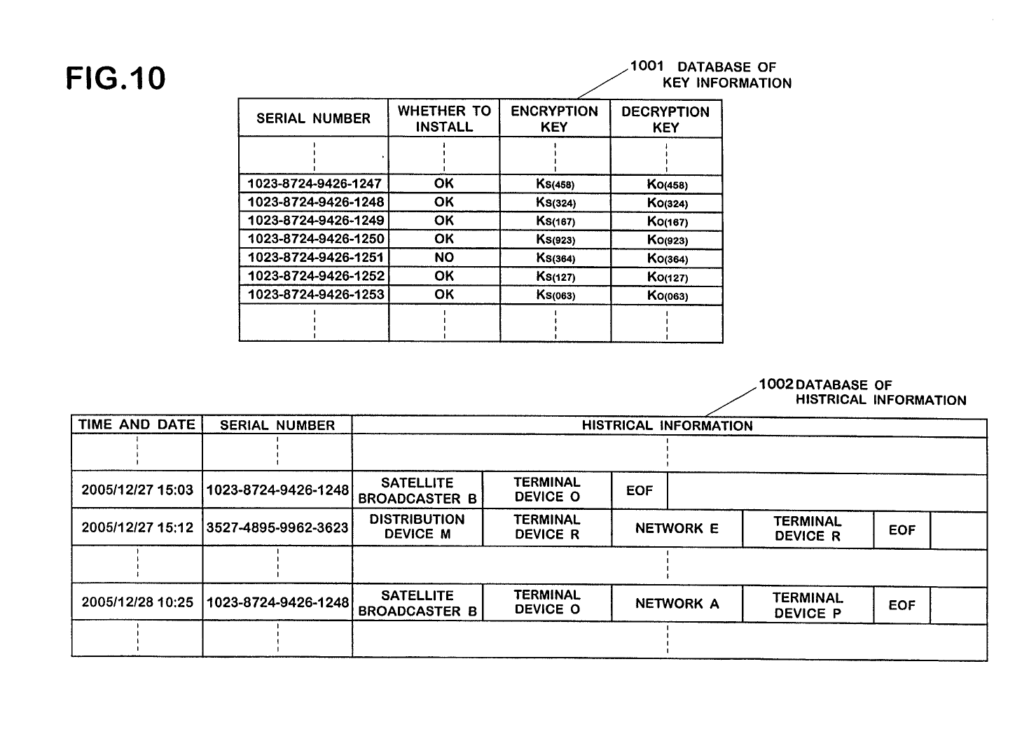

FIG. 10 is a chart showing the configuration example of information held in the distribution information storage means 903. This embodiment comprises of 2 databases including key control information database 1001 and history information control database 1002. In the key control information database, the installation propriety, the encryption key, and the decryption key are recorded as a data for each serial number of the software control information database 1001. The history information control database 1002 is that the data-and-hour of receiving or the data-and-hour of recording the history information, the serial number of each software and its history information are recorded.

The distribution propriety determination means 902 records the received history information in the history information control database 1002 (S603). In this case, the date and time of receiving “Dec. 28, 2005 10:25”, the serial number “1023-8724-9426-1248”, and the contents of the received history information (contents of FIG. 7(c)) are recorded as shown. The serial number is then inquired (S604).

In this case, the key control information database 1001 is searched about the serial number “1023-8724-9426-1248”, the installation propriety of this serial number is recorded as “approved”, so that the data is determined as “distribution approved”. By the way, when the serial number is “1023-8724-9426 -1251”, the installation propriety is recorded as “disapproved”, so that the data is determined as “distribution disapproved”. When any problem (such as bugs) occurs in the distributing software, controlling the distribution is possible by changing the content of the installation propriety on this key control information database 1001 updated.

The distribution propriety determination means 902 then gets the decryption key k0(324) corresponding to the serial number from the key control information database 1001. The distribution related information transmission means 904 outputs this decryption key k0(324) to the bus connected to the outside connection device 104, and then transmits to the installation program working on PC 172. When the data is determined as “distribution disapproval”, information indicating the distribution disapproval is transmitted (S606). In this time, the installation program on PC 172 waits for receiving this response information (S614, S615).

When the installation program receives this response information, the program looks up this information contents to determine the installation propriety (S616). In this example, the decryption key is looked up whether it is included in the response information, and then the program determines that the installation is approved if included or the installation is disapproved if not included. This determination can also be determined whether information of “installation disapproved” or “installation approved” exists in the response information.

When the data is determined as “installation disapproved”, this process is terminated at this point (S618). In this case, the application program data 206 is used to execute the installation process because of the exist of “installation approved”. Although the application program data 206 is encrypted with the encryption key ks(324), the decryption key k0(324) is received, so that the data can be decoded with the key and executed to install.

When PC 172 uses the optical disk drive therein to record the software 200 in the optical disk, the history information is as well updated by the transfer program described above and the data is transferred. FIG. 7(d) is a diagram showing the history information after updated, in which information of the recorded medium of “D-optical disc” is added.

When this optical disc is inserted into other terminal to transfer it to the PC called “terminal Q”, transmission of the software is as well carried out according to the history information updated with the contents shown in FIG. 7(e) by the transmission program 203. Furthermore, when the data is transmitted to the semiconductor memory called “S-IC card”, data transmission is as well carried out according to the history information updated with the contents in FIG. 7(f) by the transmission program 203. FIG. 7(g) shows the updated history information contents when the information is uploaded to the homepage of the server “H-outside distribution device” connected to the network, in order to subsequently distribute the software to many terminals.

Referring now in FIG. 3, the process operation is described when the backup generating program is started by the control program 201 (S306). In this embodiment, the backup generating program is stored in the software 200 as one part of the control program 201. The backup generating program activated by the control program 201 starts replicating process of the software 200. At this time, the replication others than the transmission program 203 and the backup preparation program is processed. During that process, if the control program is configured to be directly renewed and replicated to start the installation program, it is effective because the capacity of the backup program to be generated can be reduced.

The backup program generated in this way can execute the reinstallation of the application program instead of the original software, for example, when the installed application program data is destroyed.

In this embodiment, although this backup generating program was configured not to be replicate the transmission program 203, by adjusting the process contents to also replicating this, the buck-up program with capable of transmitting the software can be generated instead of the former software 200. In addition, by adjusting the configuration for replicating the backup program also, the backup program with capable of generating another backup program can be generated.

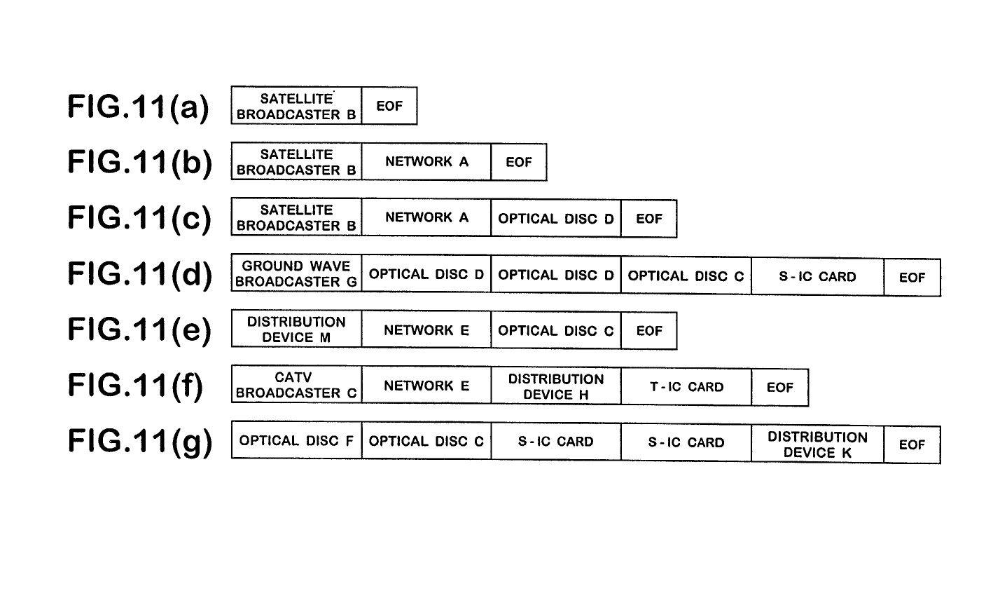

FIG. 11 is a example of the history information in another embodiments. In this embodiment, the history information with regard to the terminal is not recorded, but only Information with regard to the transmission medium is recorded. When the transmission program can hardly obtain information with regard to the terminal program, when the distribution center 101 doesn't need information with regard to the terminal, or when the collecting of information of the respective terminals as the history information that the distribution center carries out can cause a social problem, such configuration is effective. On the other hand, it may also be configured that the transfer program prompts to input information with regard to the terminal to a user, and then it is recorded as FIG. 7 only when it is input, or only the history of the transmission medium is recorded as FIG. 11 when it is not input. Whether, FIG. 11(a) is history information in this embodiment corresponding to FIG. 7(a) or FIG. 7(b), FIG. 11(b) is corresponding to FIG. 7(c), FIG. 11(c) is corresponding to FIG. 7(d) or FIG. 7(e).

In addition, FIG. 11(d) or (g) is a diagram showing the data example of history information when the software is distributed through another transmission route. As is apparent from the diagram, the distribution center 101 can control through which transmission route this software distributed, even if it is configured that only information with regard to the transmission medium used for transmission is recorded as the history information.

Other embodiments for updating the history information is described below.

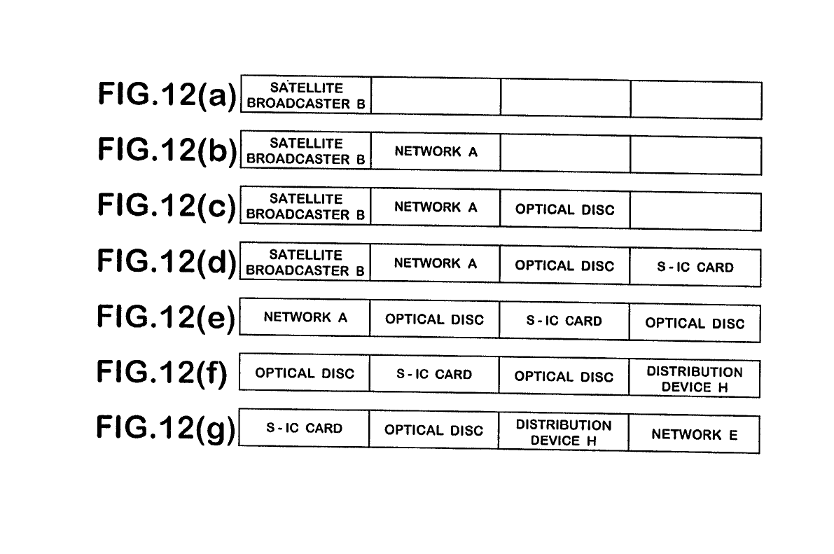

FIG. 12 is a diagram showing the manner that history information 204 is added in this embodiment. However, because the number of history information is limited in 4, when the “optical disc” is added to rear part of FIG. 12(d), “B satellite broadcast station” as oldest history is destroyed to shift another data and thus this additional operation is carried out. By adjusting such configuration, the frequent transfer process of the software can prevent the data amount of history information 204 from extremely increasing, and thus recording medium for recording the software and load of the transfer process can be decreased at this case. In addition, because at least history information with regard to the latest transmission route is transmitted to the distribution control device 103, information through which route this software is delivered finally can be obtained. When the embodiment is such that the serial number and the terminal information are recorded in the distribution information storage means, part of the missing, history information can be reconstructed from the past information of the same software such as history, terminal, or time information.

When data have to be added more than predetermined number of history information depending on the application of the history information to be collected, configuration that the history information already recorded is not deleted but new data is not added can be employed. In this case, distribution control device 103 can obtain information with regard to the first route of the software.

Furthermore, the configuration can be employed such that the limitation is not limited to the number of data, but for example, limiting by total capacity of the history information area.

Also in this case, the software received the data broadcasting of the satellite broadcast is described in the case of distributing through network, optical disc, or semiconductor memory, however, the distribution process is also possible as well as when using other route. For example, when this software is downloaded in PC 124 by data broadcasting from the ground wave broadcasting station 121 to distribute to others, the transfer is carried out by the transfer program 203 of the same software shown in FIG. 2 (which only a serial number is different), and the installation to the terminal is carried out by the installation program 205. The process is the same as above when it is broadcasted through the CATV broadcasting station 131.

Furthermore, the process is carried out in the case of the outside distribution device 141. When the data is downloaded from the homepage of the outside distribution device 141 to each terminal, the transfer program 203 of this software 200 held in the outside distribution device 141 is used to carry out the transfer process, but when the download process is required to be carried out in the control of the terminal sides, the configuration may be employed such that the transfer program 203 or the transfer program for exclusive use of the process is initially downloaded in the terminal, and then the download of the main body of the software is executed by the downloaded transfer program. Or, as described below, the downloading may be carried out by using the copy function in the PC sides, for example the download function in the operating system or the internet browser. In this case, if information that the transmission medium is network is initially added to the history information at the stage of storing of this software in the outside distribution device 11, subsequent distribution is carried out in the state of the history information similar to the process in the transfer program, even if the software is downloaded by using the copy function in PC sides not having the update function of the history information. As described below, the configuration may be employed to omit the process with regard to the update of the history information in this case.

By recording medium device 105, also when this software is distributed through the transportable data recording medium 161 such as optical disc, the same distribution is possible by recording the same software 200 in this data recording medium 161, and carrying out the same transfer process and the installation process. It is similar in the case of transmitting by using the recording medium 162 from PC 173 to PC 174. Furthermore, when hand-held terminal 182 or PC 175 carries out the transfer or installation of this software by the telephone line 183 connected to the network server 176, the transfer program 203 of this software 200 and the installation program 205 are similarly started and proceed the above process with the distribution center 101 to carry out as above.

In this embodiment, the network 151 is used to transmit the distribution related information from PC as a terminal to the distribution center 101, but the configuration may be employed to carry out the transmission with the two-way CATV line. In this case, because the configuration is employed that the CATV broadcasting station 131 having received this data transmits this data through the outside connection device 104 to the distribution control device 103 of the distribution center 101, the transmission can be executed without any problem. In addition, FIG. 1 does not illustrate, but it is understood that the configuration that connects the distribution control device 103 itself of the distribution center 101 to the telephone line and transmit through the telephone line.

In addition, when the transfer of the software using the specific transmission medium is desired to be limited, this can be carried out by limiting the type of the respective transfer programs stored in the transfer program 203. For example, as illustrated in FIG. 4 in the embodiments described above, 6 types of the transfer programs are provided, but by unmounting the specific transfer program of the transmission medium to be prohibited, the software cannot be transferred with using its transmission medium.

The transfer process of the software using the copy function of PC sides can be limited by using this configuration and employing the configuration that the software is transferred only to the recording medium with copyright protection. More specifically, it is preferred to employ the configuration that the software 200 is recorded to the recording medium with prohibited copy function and then only the transfer program 203 decrypts the protection to execute the copy.

On the contrary, instead of limiting the distribution, the rapid distribution of the software is desired, for example, when distribution of the modified software of the bugs is desired, it is preferred to employ the configuration that these limitations are removed. In this case, when the transfer of the software is started by the copy function of PC sides, the distribution of the software is carried out without the history information 204 is updated, but when the distribution control device 103 receives the history information without updated, it is preferred that the process is carried out as the software was transferred by the copy function. In addition, in the embodiment that information with regard to the terminals is transmitted to the distribution center 101, when the history information having other terminal information as the final history data is received, the configuration that processes as the transfer of the software not depending on the transfer program 203 occurred during this time can be employed.

In addition, the limitation of the transfer function of the transfer program 203 may be made a difference depending on the serial number or the first transmission route even if it is the same software. By doing this way, the transmission route of the software distribution can be totally controlled by the distribution center sides.

At any rate, in these embodiments described above, the distribution center 101 sides is no process load in the transfer of the software, so that the effective software distribution is possible. In addition, the transfer of the software from the distribution center 101 is not necessary, so that the process load of the total distribution center 101 is reduced and effective.

In addition, because the distribution related information is surely transmitted to the distribution center during installation, it is possible to control the software during distribution. Also, because the installation propriety can be controlled by each serial number, the distribution of the unlimited software or the distribution of the specific software can be limited. Furthermore in these embodiments, because the history information is transmitted to the distribution center by each of the installation of this software, it is greatly useful for controlling the distribution of the software. More specifically, when the distributed software is upgraded or when the modified program such as the bug is distributed, the history information can be analyzed to take the effective distribution method. In addition, this history information can be utilized to the marketing in which the relevant software is distributed.

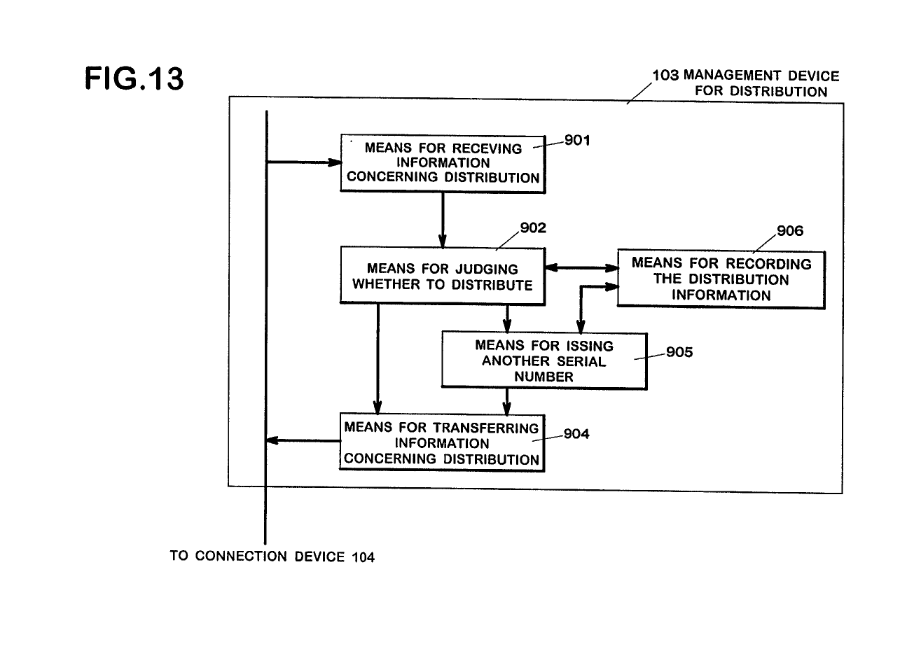

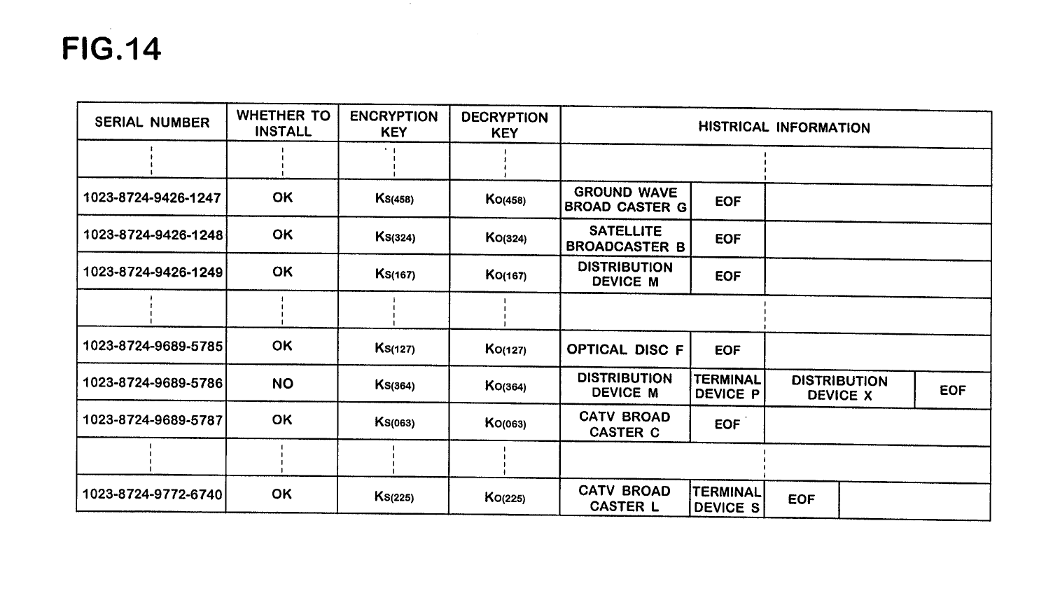

The structure of the distribution control device 103 in another embodiment is described hereinafter. FIG. 13 is diagram showing the configuration example of the distribution control device 103 in this embodiment. In addition, the same numbers are given to means having the same function as the configuration shown in FIG. 9, and the different part will be described without detailed description. Numeral 905 is a new serial number issuing means provided for this specific embodiment, in which a new serial number is issued when the distribution propriety determination means 902 determines “installation approved.” In addition, the database illustrated by FIG. 14 is memorized in this embodiment. In this database, it is configured that data is sorted in numerical order of the serial of the software, and the installation propriety, the encryption key, the decryption key and the history information are stored.

The process operation in this embodiment is described with reference to an example in which the software 200 is distributed through the data broadcast of the satellite broadcast and the network, as well as the embodiment described above. The software 200 with its serial number “1023-8724-9426-1248” is being distributed from the distribution device 102 to the satellite broadcasting station 111. At this time, the contents of the history information 204 of the software 200 is in a state of FIG. 7(a), and the same contents are also recorded in the history information recorded in the distribution information storage means 906(refer to the data of the serial number “1023-8724-9426 -1248” in FIG. 14).

Next, when the present software transmitted as data of the data broadcast is downloaded from STB 114 to PC 116, the process as used in the prior embodiments is carried out such that the history information of the software 200 is updated to that shown in FIG. 7(b). When the user starts the installation program 205 from the control program 201 to install the application of the software into PC116, the installation allowance request, serial number “1023-8724-9426 -1248”, and the history information (FIG. 7(b)) are transmitted through the network 151 to the distribution control device 103 of the distribution center 101. This distribution related information is received by the distribution related information receiving means 901 in the distribution control device 103 of FIG. 13, and then this information is transferred to the distribution propriety determination means 902. The distribution propriety determination means 902 accesses the distribution information storage means 906 to determine whether this distribution request is propriety. Referring to the data of the distribution information storage means 906 shown in FIG. 14, the propriety of the software of the serial number “1023-8724-9426 -1248” is recorded as “approved” such that “installation approved” is determined and then the decryption key K0(324) is acquired. The new serial number issue means 905 is started when the distribution propriety determination means 902 determines “installation approved”, this new serial number issue means 905 issues a new serial number which has never been given with reference to the database of FIG. 14 and also makes new data about this number on this database. In order to issue a new serial number in the case of this database, the serial number of the final data “1023-8724-9772 -6740” may be incremented to get “1023-8724-9772 -6741” since it is sorted in order of the serial number.

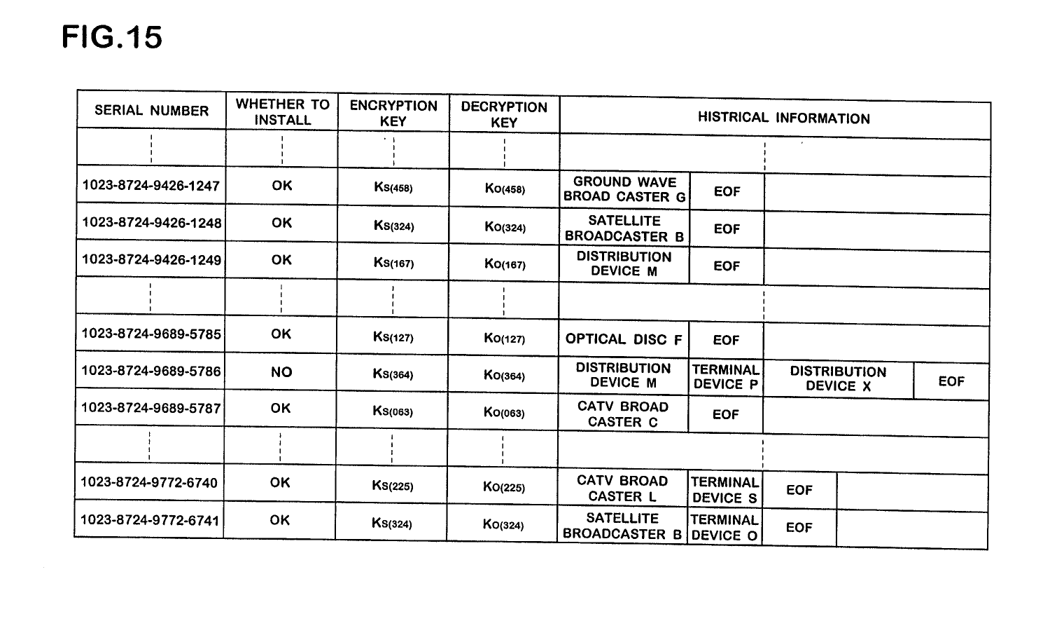

The new serial number issue means adds the serial number “1023-8724-9772-6741” to the database of FIG. 14, and duplicates the installation propriety, the encryption key, and the decryption key, and then records the received installation information. The contents of the updated database in such a manner is shown in FIG. 15.

After this, the distribution related information transmission means 904 transmits the allowance information of “installation approved”, the decryption key K0(324), and the new serial number “1023-8724-9772 -6741” to the installation program 205. Installation program performs the installation process based on the allowance information of “installation approved.” At this time, the serial number 202 is updated to this new serial number such that the application program data 206 decrypts with the decryption key K0(324).

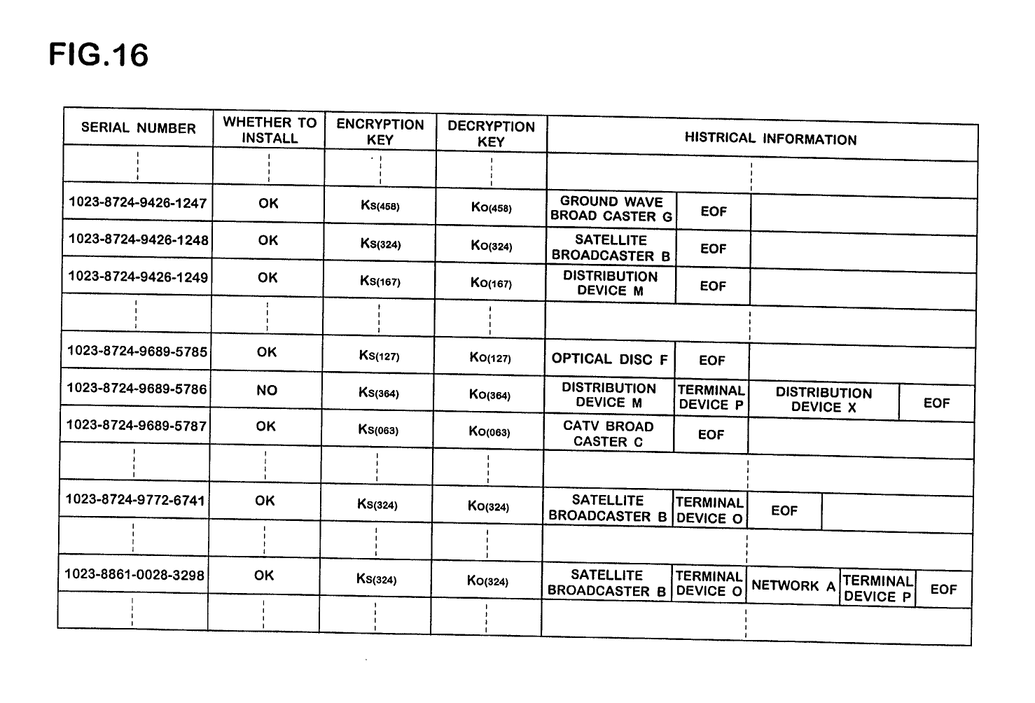

Similarly, the software is transferred through the network 151 to PC 172, and the new serial number issue means 905 will issue the new serial number “1023-8861-0028-3298” when the installation program is started, and then the history information at that time (FIG. 7(c)) is added to the database of the distribution information storage means 906 (FIG. 16).

According to the embodiment as described above serial numbers are individually given to all the application programs to be installed in the terminal devices such as PCs, and thus subsequent control is carried out as well as when the software are respectively distributed. In addition, a configuration such that, when the installation program transmits installation allowance request to the distribution control device 103, the user's personal information is also transmitted, allows to utilize for supporting this application program thereafter.

Further in this embodiment, it is easily understood that the database recorded in the distribution information storage means 906 is configured as one thing, but it may be divided into 2 or more databases to control, as in the embodiment described above.

Further in this embodiment, although the application program of the software 200, is encrypted it is desirable that the serial number, transfer program, and the installation program are also encrypted to improve the security of this distribution program. In addition, it is effective that communication data between the terminal device and the distribution center is encrypted to transmit for preventing from altering data and illegal acquirement of the decryption key.

Further in these embodiments, although the software 200 is a group of programs and data necessary for the installation of the application program practicable in the terminal device, the practicable program may be recorded as it is. In addition, data recorded in this area is not limited to program, but it may be pure data such as stream of music and image, or static image data.

As an another application, it may be configured that, information with regard to CM is distributed itself as its application data, or CM data is attached to these application program or application data to distribute, so that the transmission route for the information with regard to the CM is collected, as information.

In addition, when the distribution center 101 gives a distribution allowance, accounting process may be carried against the user who is seeking for this distribution allowance. In this case, the accounting process can be executed easier than selling the software respectively, and it becomes possible to automate a series of the accounting process such as withdrawal pull down from bank account or credit-card.

In addition, if the distribution control device 103 has the terminal information used in the transmission route, as the history information, information with regard to the personal of its terminal is recorded in this terminal information, or information with regard to the personal is got from its terminal information, then the refund process of the software fee is administered against its personal. In this embodiment, it becomes possible to develop sales promotion for the software sales by utilizing this function.

Furthermore in the embodiment described above, although it is possible to communicate with the distribution center upon installation, the configuration in which it is possible to communicate upon installation and/or upon software transfer and at the same time a required process such as update process of serial numbers is performed is allowable, the configuration may be adjusted to carry the process such as the update of the serial number necessary for that time. By the configuration described above, it becomes possible to control the software distribution in greater detail.

In addition, although each broadcasting station such as the distribution center 101 and the satellite broadcasting station 111 is directly connected via a communication path in this embodiment, the software may be transferred therebetween, with a recording medium such as DVD.

Further in this embodiment, although the broadcast wave of the satellite broadcast is connected through STB 114 to the image receiving terminal 115, it is clearly understood that the output from the antenna 113 can be connected directly to the image receiving terminal having the function of receiving the satellite broadcast.

On the contrary, the broadcast wave of the ground wave is directly connected to the image receiving terminal 123 from the antenna 122 in this embodiment. If this image receiving terminal is not provided with the function of receiving data broadcast, it is connected via STB having such function, thereby to download the software received or transmitted from data broadcast. It can be also applied to CATV.

In the embodiments described in the above, approval for installation, that for transfer are inquired to the distribution control device when installation of programs and so on and transfer thereof are performed at the terminal device. It may require such approval from the control device even when other utilization processing such as operation of programs being installed is performed. In such case, the control device can also retrieve history of the operation.

Further, in the embodiments described in the above, all the data and/or programs are transferred to the terminal device. The present invention may be applied to one in which a part of these data and/or programs is kept in the control device and the remaining part is transferred to the terminal device. In such case, it is necessary for the terminal device to access to the control device in order to operate the data and/or programs at its own.

Furthermore, transmission of history information to the control device is done through the networks in the embodiments. The history information can be forwarded to the terminal device by carrying a recording medium recording history information on its transfer physically thereto and read the information therein.

What is claimed is:

1. An information distribution system comprising an information distribution management device managing distribution of information and a terminal connected to the management device so as to communicate with each other,
wherein the information to be distributed is distributed to the terminal with a utilization program for performing processing required to use the information,
wherein the terminal device performs processing for utilization of the information in accordance with processing of the utilization program,
and wherein at beginning of the utilization processing, the utilization program asks the device for permission of the utilization processing as a result of communication therewith and performs the utilization processing on receipt of the permission from the device.

2. An information distribution management device in an information distribution system, managing distribution of information,
wherein the device is connected to a terminal device so as to communicate with each other,
and wherein the device returns permission of processing for utilization of the distributed information in response to a demand for the permission which is transmitted by the terminal device at beginning of use of the distributed information in accordance with a utilization program distributed with the information.

3. A data storage medium, storing a program for managing distribution of information by which a computer functions as an information distribution management device,
wherein the program controls the computer to return permission of processing for utilization of the distributed information in response to a demand for permission which is transmitted by a terminal device at beginning of use of the distributed information in accordance with a utilization program distributed with the information.

4. A program for managing distribution of information by which a computer functions as an information distribution management device,
wherein the program performs processing in which permission of processing for utilization is returned in response to a demand for permission which is transmitted by the terminal device at beginning of use of the distributed information in accordance with a utilization program distributed with the information.

5. A terminal device, in an information distribution system, connected to an information distribution management device so as to communicate with each other,
wherein the terminal device performs processing for utilization of information in accordance with processing of a utilization program distributed with the information,
and wherein at beginning of the utilization processing, the utilization program asks the device for permission of processing of the utilization processing as a result of communication therewith and performs the utilization processing on receipt of the permission of the processing from the device.

6. A data storage medium, storing a utilization program for performing processing required to use distributed information with a computer,
wherein the program asks for permission of processing for utilization of the information as a result of communication with an information distribution management device
and wherein the program makes the computer to perform the utilization processing on receipt of the permission from the device.

7. The data storage medium of claim 6 wherein the medium also stores information together with the program.

8. A utilization program for performing processing required to use distributed information with a computer,
wherein the program asks for permission of processing for utilization of the information as a result of communication with an information distribution management device
and wherein the program makes the computer to perform the utilization processing on receipt of the permission from the device.

9. The system of claim 1 wherein the information to be distributed is a program.

10. The system of claim 1 wherein the information to be distributed is data.

11. The system of claim 1 wherein the utilization processing performed by the terminal device is processing for transfer of the distributed information,
and wherein the utilization program includes a program for transferring the information to another device.

12. The system of claim 11 wherein history of transfer is added to the information to be distributed,
and wherein the transfer program transfers the history of transfer in addition to the information,

13. The system of claim 12 wherein the transfer program transfers the history of transfer with update thereof.

14. The system of claim 13 wherein the transfer program updates the history of transfer with addition of information on a media used for the transfer.

15. The system of claim 13 wherein the transfer program updates the history of transfer with addition of information on a terminal to be a destination of the transfer.

16. The system of claim 13 wherein the transfer program add a new history of transfer with delete of previous history.

17. The system of claim 16 wherein the transfer program deletes the previous history one of cases in that storage capacity of the history of transfer exceeds a predetermined capacity and in that the number of the history recorded exceeds a predetermined number.

18. The system of claim 11 wherein the transfer program transfers the transfer program itself together with the information.

19. The system of claim 11 wherein the transfer program transfers the whole of the utilization program together with the information.

20. The system of claim 11 wherein the distributed information accompanies an information ID identifying the information.

21. The system of claim 20 wherein the transfer program used by the terminal device transmits an information ID of information when the information is transferred to the information distribution management device,
and wherein the information distribution management device determines whether or not transfer of the information is permitted in accordance with the information ID thus received.

22. The system of claim 20 wherein the information distribution management device generates a new information ID for information to be transferred and records the generated ID when a request for transferring information is received from the transfer program being executed in the terminal device, and the ID is sent to the transfer program,
and wherein the transfer program adds the new ID being received to the information to be transferred and transmits the information accompanying the new ID.

23. The system of claim 22 wherein the utilization processing of information performed by the terminal device is processing for installing the distributed information,
and wherein the utilization program includes an installation program, which makes information usable on the terminal device.

24. The system of claim 23 wherein the distributed information accompanies an information ID identifying the information.

25. The system of claim 24 wherein the installation program in the terminal device transmits the ID accompanied by the information at beginning of information transfer,
and wherein the information distribution management device determines whether or not whether or not installation of the information is permitted in accordance with the information ID thus received.

26. The system of claim 24 wherein the information distribution management device generates a new information ID for information to be transferred and records the generated ID when a request for installing information is received from the installation program being executed in the terminal device, and the ID is sent to the installation program,
and wherein the installation program adds the new ID being received to the information to be installed and transmits the information accompanying the new ID.

27. The system of claim 23 wherein historical information of its transfer is added to the information to be transferred, and the installation program in the terminal device transmits the historical information to the information distribution management device,
and wherein the management device not provides to the installation program in the terminal device permission for installation of the information when no historical information of its transfer is received.

28. The system of claim 23 wherein the information to be distributed is encrypted,
and wherein the management device transmits a cipher key for decryption to the installation program when installation is permitted in response to a request for installation.

29. A data storage medium, storing information to be distributed, historical information of its transfer and a utility application, wherein the historical information is stored at a region for storing history of transfer in a past and at another region for storing a new history of transfer,
and wherein the new history is additionally written therein with the utility application executed by the terminal device at which the information is distributed.

30. A historical information storage medium, storing historical information of information to be transferred associated with each other, wherein the historical information of the transferred information is recorded for every transfer of the information at separate regions,
and wherein storage medium has a structure in which historical information is additionally recorded therein for every transfer of information with a terminal device, which performs the transfer of the information.

31. A tracking method for recording a distribution path of information distributed to a terminal device connected one of directly and indirectly with an information distribution management device, the method being used at the management device, wherein the information to be distributed is transmitted together with a program for transferring the information,
wherein the transfer program updates the information on distribution path and transmits to the management device the updated information on distribution path when information is transferred to another device with the terminal device,
and wherein the distribution path for the information is recorded in the management device thereby the distribution path for the information is tracked.

32. A method of distributing information through one of a network and a media, wherein a distribution source adds to information to be distributed a utilization program, which makes the information usable and distributes the resultant information,
and wherein at an information user receiving the information, the information is not able to use on receipt of permission of use thereof which is obtained by utilizing the program.

33. A system comprising a program distribution management device for managing information on program distribution and terminal devices connected to the management device via a communication line, wherein on a program storage medium inserted in a terminal device, an application program and an installation program for installing the application program into the terminal device is recorded,
wherein the installation program transmits to the management device a request for permission as to the installation via the communication line,
and wherein installation processing of the application program is performed only when permission for the request is received from the management device.

34. A system comprising a data distribution management device for managing information on data distribution and terminal devices connected to the management device via a communication line, wherein on a program storage medium inserted in a terminal device, specific application data and an installation program for installing the application data into the terminal device is recorded,
wherein the installation program transmits to the management device a request for permission as to the installation of the application data via the communication line,
and wherein installation processing of the application data is performed only when permission for the request is received from the management device.

35. A program distribution management device comprising:
receiving means, receiving a request for permission of distribution including information for identifying programs from a terminal device connected to the device;
recording means, recording a possibility of distribution whether or not distribution of the programs being permitted per every information for dentifying the programs;
judging means, obtaining information on a possibility of distribution according to the information for identifying the programs as a result of conducting a search in the recording means when the receiving means receives a request for permission of distribution; and
transmission means, transmitting to the terminal device information on permission of the distribution when a judgement of the judging means permits the distribution.

36. A data distribution management device comprising:
receiving means, receiving a request for permission of distribution including information for identifying data from a terminal device connected to the device;
recording means, recording a possibility of distribution whether or not distribution of the data being permitted per every data for identifying the data;
judging means, obtaining information on a possibility of distribution according to the information for identifying the data as a result of conducting a search in the recording means when the receiving means receives a request for permission of distribution; and
transmission means, transmitting to the terminal device information on permission of the distribution when a judgement of the judging means permits the distribution.

37. A program storage medium storing an application program and an installation program for installing the application program into a terminal device, wherein the installation program transmits to a program distribution management device connected to the terminal device a request for permission as to installation of a program prior to install the application program into the terminal device,
and wherein installation processing of the application program is performed only when permission for the request is received from the management device.

38. A program storage medium storing an application data and an installation program for installing the application data into a terminal device, wherein the installation program transmits to a data distribution management device connected to the terminal device a request for permission as to installation of a program prior to install the application data into the terminal device,
and wherein installation processing of the application data is performed only when permission for the request is received from the management device.

39. A terminal device capable of executing an application program, wherein a program storage medium inserted therein stores an application program,
historical information of its transfer, and
a program for transferring the application program, the historical information and the transfer program itself to another terminal device,
and wherein the transfer program executes transfer processing with addition of information on a transmission media used for the transfer.

40. A terminal device capable of processing application data, wherein a program storage medium inserted therein stores application data,
historical information of its transfer, and
a program for transferring the application data, the historical information and the transfer program itself to another terminal device,
and wherein the transfer program performs transfer processing with addition of information on a transmission media used for the transfer.

41. A program storage medium storing an application program, historical information of its transfer, a program for transferring data including the application program to another terminal device, wherein the transfer program performs transfer processing with addition of information on a transmission media used for the transfer.

42. A program storage medium storing an application data, historical information of transfer, a program for transferring data including the application data to another terminal device, wherein the transfer program performs transfer processing with addition of information on a transmission media used for the transfer.

43. A system comprising a program distribution management device for managing information on program distribution and terminal devices connected to the management device via a communication line, wherein on a program storage medium inserted in a terminal device, an application program and a program for transferring data including the application program to another terminal device is recorded,
wherein the transfer program transmits to the management device a request for permission as to the transfer via the communication line,
and wherein transfer processing is performed only when permission for the request is received from the management device.

44. A system comprising a data distribution management device for managing information on data distribution and terminal devices connected to the management device via a communication line, wherein on a program storage medium inserted in a terminal device, an application data and a program for transferring data including the application data to another terminal device is recorded,
wherein the transfer program transmits to the management device a request for permission as to the transfer via the communication line,
and wherein transfer processing is performed only when permission for the request is received from the management device.

45. A storage medium storing an application program and a program for transferring data including the application program to another terminal device, wherein the transfer program transmits to a program distribution management device connected to the terminal device a request for permission as to transfer of the program to another terminal device prior to perform transfer processing,
and wherein the transfer processing is performed only when permission for the request is received from the management device.

46. A storage medium storing application data and a program for transferring data including the application data to another terminal device, wherein the transfer program transmits to a data distribution management device connected to the terminal device a request for permission as to transfer of the data to another terminal device prior to perform transfer processing,
and wherein the transfer processing is performed only when permission for the request is received from the management device.

47. A program distribution management device comprising:
receiving means, receiving historical information on distribution of a program from a terminal device connected to the management device; and
transmission means, transmitting a message for confirming receipt of the historical information to the terminal device when the receiving means receives the historical information.

48. A program distribution management device comprising:
receiving means, receiving a request for permission of distribution including information for identifying programs and historical information on distribution of the program from a terminal device connected to the device;
recording means, recording a possibility of distribution whether or not distribution of the programs being permitted per every information for identifying the programs;
judging means, obtaining information on the possibility of distribution according to the information for identifying the data as a result of conducting a search in the recording means when the receiving means receives the request for permission of distribution and the historical information; and
transmission means, transmitting to the terminal device information on permission of the distribution when a judgement of the judging means permits the distribution.

49. A data distribution management device comprising:
receiving means, receiving historical information on distribution of application data from a terminal device connected to the management device; and
transmission means, transmitting a message for confirming receipt of the historical information to the terminal device when the receiving means receives the historical information.

50. A data distribution management device comprising:
receiving means, receiving a request for permission of distribution including information for identifying application data and historical information on distribution of the application data from a terminal device connected to the device;
recording means, recording a possibility of distribution whether or not distribution of the application data being permitted per every information for identifying the application data;
judging means, obtaining information on the possibility of distribution according to the information for identifying the data as a result of conducting a search in the recording means when the receiving means receives the request for permission of distribution and the historical information; and
transmission means, transmitting to the terminal device information on permission of the distribution when a judgement of the judging means permits the distribution.
